(19) United States
(12) Patent Application Publication
(10) Pub. No.: US 2014/0027535 A1
(43) Pub. Date: Jan. 30, 2014

(54) METHOD FOR PROVIDING PHOTORESIST AND PHOTORESIST DISPENSING APPARATUS

(71) Applicant: Yu-Chun Pan, Miaoli County (TW)

(72) Inventor: Yu-Chun Pan, Miaoli County (TW)

(21) Appl. No.: 13/562,258

(22) Filed: Jul. 30, 2012

(51) Int. Cl. B05B 9/00

(52) U.S. Cl. 239/101; 141/4

(57) ABSTRACT

A method for providing a photoresist includes providing a pressure reducing and increasing device connected to a photoresist storage bottle and a photoresist supply tank; and performing a pressure reducing step to create a suction force to move a photoresist from the photoresist storage bottle into the photoresist supply tank.

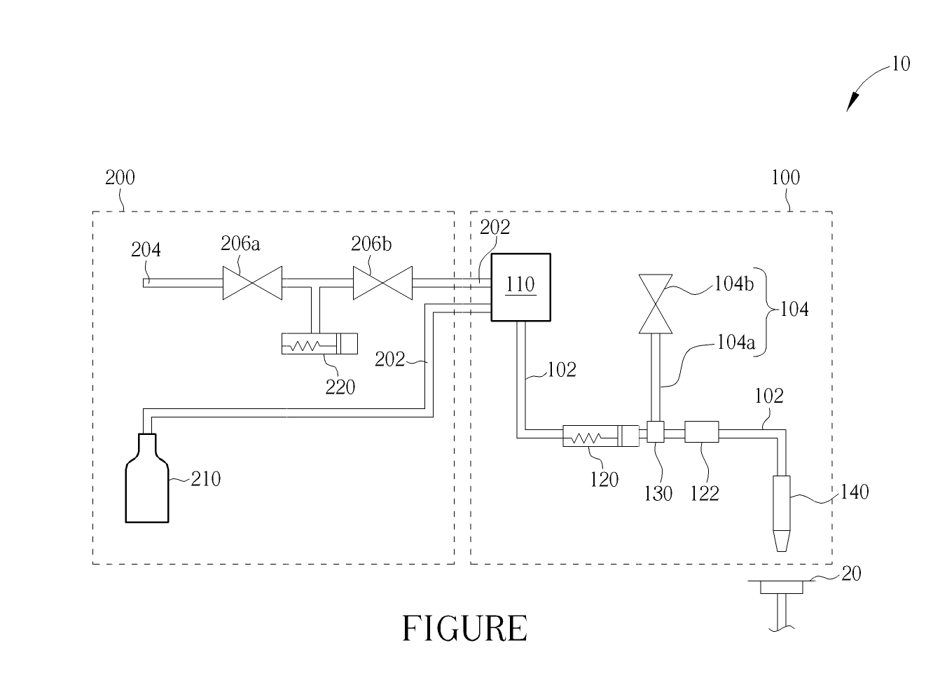

### BACKGROUND OF THE INVENTION

1. Field of the Invention

The present invention relates to a method for providing photoresist and a photoresist dispensing apparatus, and more particularly, to a method for providing photoresist to a photoresist dispensing apparatus.

2. Description of the Prior Art

Photoresists are commonly used in the formation of particular structures on a wafer. In typical manufacturing process using photoresist, there may be a numbers of steps involving deposition of layers, photolithography, ion implantation, etching, and numerous other processes. Conventionally, the photoresist is dispensed to a wafer and then exposed to a light through a reticle. Thus patterns, which are to be formed on the wafer, are transferred from the reticle to the photoresist. Subsequently, the exposed portion or unexposed portion of the photoresist is removed to form a patterned photoresist and then the following ion implantation, etching, and any required processes are performed.

In the state-of-the-art, the photoresist is temporarily stored in a photoresist tank (PR tank) and is transported to a spray nozzle and then be dispensed to a wafer. When the photoresist in the PR tank is not enough, it is always in need to refill the PR tank with the required photoresist. Conventional method for refilling the PR tank utilizes N₂ gas to pressure the photoresist from a PR storage bottle into the PR tank. However, it has been found that by using the N₂ gas to pressure the photoresist and thus make it flow into the PR tank, countless unfilterable micro-bubbles are generated. Furthermore, the micro-bubbles generated in the photoresist flow into PR tank and then are dispensed to the wafer with the photoresist. It has been confirmed that the micro-bubbles adversely impact the quality of photoresist sprayed onto the wafer, it even adversely impact the final patterned photoresist.

In view of the foregoing, it is desirable to provide a method or a mechanism for providing photoresist that is able to eliminate the micro-bubble issue.

### SUMMARY OF THE INVENTION

According to an aspect of the present invention, a method for providing a photoresist is provided. The method includes providing a pressure reducing and increasing device connected to a photoresist storage bottle and a photoresist supply tank; and performing a pressure reducing step to create a suction force to move a photoresist from the photoresist storage bottle into the photoresist supply tank.

According to another aspect of the present invention, a photoresist dispensing apparatus is provided. The photoresist dispensing apparatus includes a working unit and a non-working unit. The working unit includes a photoresist supply tank and a photoresist spray nozzle connected to the photoresist supply tank. The non-working unit includes at least a photoresist storage bottle and a pressure reducing and increasing device connected to the photoresist storage bottle in the non-working unit and the photoresist supply tank in the working unit.

According to the method for providing photoresist and the photoresist dispensing apparatus provided by the present invention, the photoresist is transported from the photoresist storage bottle into the photoresist supply tank by a suction force which is generated by the pressure reducing and increasing device. Consequently, no extra gas is utilized to pressure and transport the photoresist and thus no micro-bubbles are produced. In other words, the method for providing photoresist and the photoresist dispensing apparatus provided by the present invention successfully eliminates the micro-bubble issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGURE is a schematic drawing illustrating a photoresist dispensing apparatus provided by a preferred embodiment of the present invention.

### DETAILED DESCRIPTION

Please refer to FIGURE, which is a schematic drawing illustrating a photoresist dispensing apparatus provided by a preferred embodiment of the present invention. As shown in FIGURE, the preferred embodiment provides a photoresist dispensing apparatus 10. The photoresist dispensing apparatus 10 includes a working unit 100 and a non-working unit 200. The working unit 100 includes a configuration similar to the conventional photoresist dispensing apparatus. Accordingly, the working unit 100 includes a photoresist supply tank 110 for temporarily storing a predetermined volume of photoresist and stably providing the photoresist. A plurality of sensors or detectors can be adopted on inner walls of the photoresist supply tank 110 for detecting the volume of the photoresist remained therein. The working unit 100 of the photoresist dispensing apparatus 10 also includes a pump 120 for pumping the photoresist, a suck-back valve 122 for preventing back-flowing of the photoresist, a filter 130 for filtering unwanted substance from the photoresist, and a photoresist spray nozzle 140 for spraying the photoresist to a subject wafer 20. Those skilled in the art would easily realize that supply lines 102 are provided in the working unit 100 for connecting the photoresist supply tank 110, the pump 120, the filter 130, the suck-back valve 122, and the spray nozzle 140. In addition, a drain 104 is provided in the working unit 100. The drain 104 includes a drain line 104a and a drain valve 104b. When different types of photoresist is required, the photoresist previously used and remained in the working unit 100 is drained out from the working unit 100 by the drain line 104a and is prevented from flowing back into the working unit 100 by the drain valve 104b. Accordingly, the pump 120 is operated to move the photoresist from the photoresist supply tank 110 to the photoresist spray nozzle 140 through the supply lines 102 while the filter 130 providing filtering function and the drain line 104a providing draining function during photoresist replacement. In other words, the working unit 100 includes elements that directly involving in dispensing the photoresist to the subject wafer 20.

The non-working unit 200 of the photoresist dispensing apparatus 10 includes at least a photoresist storage bottle 210 which is purchased from a photoresist Vendor and a pressure reducing and increasing device 220 connected to the photoresist supply tank 110 in the working unit 100. The pressure reducing and increasing device 220 includes a pump, such as a syringe. It is well-known that a syringe is a simple pump consisting of the plunger that fits tightly in a cylindrical tube, so-called a barrel, allowing the syringe to take in and expel gas and thus reduces or increases the pressure. Also, the non-working unit 200 includes supply lines 202 connecting the photoresist storage bottle 210, the pressure reducing and increasing device 220, and the photoresist supply tank 110 in the working unit 100. The non-working unit 200 also includes a drain 204 connected to the pressure reducing and increasing device 200. As shown in FIGURE, a valve 206a is adopted on the supply line 202 between the drain 204 and the pressure reducing and increasing device 220, and a valve 206b is adopted on the supply line 202 between the photoresist supply tank 110 and the pressure reducing and increasing device 220.

As mentioned above, since the level sensors are adopted in the inner walls of the photoresist supply tank 110, a signal may be sent out when the photoresist remained in the photoresist supply tank 110 is not enough. Then, the pump 120 is stopped after certain amount of wafer is undergone the photoresist dispensing and the suck-back valve 122 is closed. Operators are required to replace the empty photoresist storage bottle 210, and the photoresist supply tank 110 needs to be re-filled. Subsequently, a pressure reducing step is performed by the pressure reducing and increasing device 220 to create a suction force to move the photoresist from the photoresist storage bottle 210 directly into the photoresist supply tank 110 according to the method for providing the photoresist of the preferred embodiment. It is noteworthy that when the pressure reducing and increasing device 220 is a syringe, in a preferred embodiment, the barrel of the syringe preferably includes a capacity larger than a capacity of the photoresist supply tank 110. Thus, the photoresist supply tank 110 is refilled with the photoresist by performing the pressure reducing step only one time.

According to the method for providing the photoresist of the preferred embodiment, a pressure increasing step is performed after the pressure reducing step. The pressure increasing step is performed by the pressure reducing and increasing device 220 to obtain an original pressure in the pressure reducing and increasing device 220. As mentioned above, when the pressure reducing and increasing device 220 is the syringe having the capacity larger than the photoresist supply tank 110, an excessive photoresist always obtained after the pressure reducing step. Therefore the pressure increasing step simultaneously removes bubbles and the excessive photoresist from the photoresist supply tank 110 to the drain 204, and thus the excessive photoresist is collected and reused. Accordingly, no photoresist is wasted. More important, when the next pressure reducing step is performed, the drain valve 206b prevents the excessive photoresist from flowing back into the photoresist supply tank 110 during the pressure increasing step. It should be noted that the valve 206a and the valve 206b prevent the photoresist and any unwanted bubbles from flowing back to the pressure reducing and increasing device 220 and to the photoresist supply tank 110 during the pressure increasing step. Additionally, it should be noted that the pressure reducing step and the pressure increasing step are performed manually or automatically.

More important, because the photoresist is transported by the suction force, which is created by the pressure reducing step, no extra gas such as N₂ is required. And thus no un-filterable micro-bubbles are caused during extracting the photoresist from the photoresist storage bottle 210. In other words, the micro-bubbles are eliminated not only during extracting the photoresist from the photoresist storage bottle 210 but also during filling the photoresist supply tank 110. Consequently, the photoresist dispensing apparatus no longer needs the micro-bubble filters between the photoresist storage bottle 210 and the photoresist supply tank 110. Furthermore, it is observed that the pressure reducing and increasing device 220 is positioned between the drain 204 and the photoresist supply tank 110, therefore the original manifolds such as the supply lines 202 are not impacted. In other words, adoption of the pressure reducing and increasing device 220 provided by the present invention will not increase undesirable cost.

According to the method for providing photoresist and the photoresist dispensing apparatus provided by the present invention, the photoresist is transported from the photoresist storage bottle into the photoresist supply tank by a suction force which is generated by the pressure reducing and increasing device. Consequently, no extra gas is utilized to pressure and transport the photoresist and thus no micro-bubbles are caused. In other words, the method for providing photoresist and the photoresist dispensing apparatus provided by the present invention successfully eliminates the micro-bubble issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for providing a photoresist comprising:
providing a pressure reducing and increasing device connected to a photoresist storage bottle and a photoresist supply tank; and
performing a pressure reducing step to create a suction force to move a photoresist from the photoresist storage bottle into the photoresist supply tank.

2. The method for providing the photoresist according to claim 1, further comprising at least a drain connected to the pressure reducing and increasing device.

3. The method for providing the photoresist according to claim 2, further comprising performing a pressure increasing step to obtain an original pressure in the pressure reducing and increasing device.

4. The method for providing the photoresist according to claim 3, wherein the pressure increasing step simultaneously removes an excessive photoresist from the photoresist supply tank to the drain.

5. The method for providing the photoresist according to claim 4, further comprising at least a valve for preventing the excessive photoresist from flowing back into the photoresist supply tank during performing the pressure increasing step.

6. The method for providing the photoresist according to claim 1, wherein the pressure reducing step and the pressure increasing step are performed manually.

7. The method for providing the photoresist according to claim 1, wherein the pressure reducing step and the pressure increasing step are performed automatically.

8. The method for providing the photoresist according to claim 1, wherein the pressure reducing and increasing device comprises a pump.

9. The method for providing the photoresist according to claim 8, wherein the pressure reducing and increasing device comprises a syringe.

10. A photoresist dispensing apparatus comprising:
a working unit comprising:
a photoresist supply tank; and
a photoresist spray nozzle connected to the photoresist supply tank; and
a non-working unit comprising:
at least a photoresist storage bottle; and
a pressure reducing and increasing device connected o the photoresist storage bottle in the non-working unit and the photoresist supply tank in the working unit.

11. The photoresist dispensing apparatus according to claim 10, further comprising at least a drain connected to the pressure reducing and increasing device.

12. The photoresist dispensing apparatus according to claim 11, wherein the pressure reducing and increasing device performs a pressure reducing step to create a suction force to move a photoresist from the photoresist storage bottle into the photoresist supply tank.

13. The photoresist dispensing apparatus according to claim 11, wherein the pressure reducing and increasing device performs a pressure increasing step to obtain an original pressure in the pressure reducing and increasing device.

14. The photoresist dispensing apparatus according to claim 1 3, wherein the pressure increasing step simultaneously removes an excessive photoresist from the photoresist supply tank to the drain.

15. The photoresist dispensing apparatus according to claim 14, further comprising at least a valve for preventing the excessive photoresist from flowing back into the photoresist supply tank during performing the pressure increasing step.

16. The photoresist dispensing apparatus according to claim 10, wherein the pressure reducing and increasing device is performed manually.

17. The photoresist dispensing apparatus according to claim 10, wherein the pressure reducing and increasing device is performed automatically.

18. The photoresist dispensing apparatus according to claim 10, wherein the pressure reducing and increasing device comprises a pump.

19. The photoresist dispensing apparatus according to claim 18, wherein the pressure reducing and increasing device comprises a syringe.

20. The photoresist dispensing apparatus according to claim 10, further comprising a pump positioned in the working unit for moving the photoresist from the photoresist supply tank into the spray nozzle.
